(19) United States
(12) Patent Application Publication
(10) Pub. No.: US 2026/0254480 A1
(43) Pub. Date: Aug. 27, 2026

(54) COMMUNICATION APPARATUS, CONTROL METHOD, AND STORAGE MEDIUM

(71) Applicant: Premo Inc., Tokyo (JP)

(72) Inventors: Hidenori Tsuji, Tokyo (JP); Shutai Okamura, Tokyo (JP)

(73) Assignee: Premo Inc., Tokyo (JP)

(21) Appl. No.: 19/650,630

(22) Filed: Apr. 17, 2026

Related U.S. Application Data
(63) Continuation of application No. PCT/JP2024/034292, filed on Sep. 25, 2024.

(30) Foreign Application Priority Data
Oct. 18, 2023 (JP) 2023-179732

(51) Int. Cl. H04B 5/48; H04B 5/26; H04L 1/18

(52) U.S. Cl. CPC H04B 5/48; H04B 5/266; H04L 1/18

(57) ABSTRACT

In a first communication apparatus, a transmission circuit including a transmitting coil performs wireless transmission to a second communication apparatus through inductive coupling between the transmitting coil of the first communication apparatus and a receiving coil of the second communication apparatus. A reception circuit including a receiving coil performs wireless reception from the second communication apparatus through inductive coupling between the receiving coil of the first communication apparatus and a transmitting coil of the second communication apparatus. A determination unit determines whether a collision occurred between wireless transmissions performed by a plurality of communication apparatuses, based on at least one of a frequency and a pulse width of a pulse sequence received via the reception circuit. In a case where the collision occurred, a control unit performs control to transmit a retransmission request to the second communication apparatus via the transmission circuit.

### CROSS-REFERENCE TO RELATED APPLICATION(S)

This application is a continuation of International Patent Application No. PCT/JP2024/034292 filed on Sep. 25, 2024, which claims priority to and the benefit of Japanese Patent Application No. 2023-179732 filed on Oct. 18, 2023, the entire disclosures of which are incorporated herein by reference.

### BACKGROUND OF THE INVENTION

### Field of the Invention

The present invention relates to a communication apparatus, a control method, and a storage medium.

### Description of the Related Art

Conventionally, technologies for performing wireless communication using coils between a plurality of semiconductor chips are known. For example, Japanese Patent Laid-Open No. 2021-87044 discloses an information processing apparatus that uses short-range wireless communication to perform exchange of information between a plurality of horizontally integrated semiconductor chips.

Japanese Patent Laid-Open No. 2021-87044 describes a collision detection circuit, and while consideration is given to the fact that data transmitted between chips may collide, no specific discussion relating to collisions is undertaken.

### SUMMARY OF THE INVENTION

The present invention has been made in view of such circumstances and provides a technology that improves the possibility of retransmission being performed in the case of a collision occurring in a communication system.

According to an aspect of the present invention, there is provided a first communication apparatus comprising: a transmission circuit including a transmitting coil and configured to perform wireless transmission to a second communication apparatus through inductive coupling between the transmitting coil of the first communication apparatus and a receiving coil of the second communication apparatus; a reception circuit including a receiving coil and configured to perform wireless reception from the second communication apparatus through inductive coupling between the receiving coil of the first communication apparatus and a transmitting coil of the second communication apparatus; and a processor which functions as: a determination unit configured to determine whether a collision occurred between wireless transmissions performed by a plurality of communication apparatuses, based on a reception signal received via the reception circuit, wherein the reception signal is a pulse sequence, and the determination unit determines whether the collision occurred, based on at least one of a frequency and a pulse width of the pulse sequence; and a control unit configured to, in a case where the collision occurred, perform control to transmit a retransmission request to the second communication apparatus via the transmission circuit.

Note that further features and advantages of the present invention will further become apparent from the attached drawings and the following description of the embodiments.

### BRIEF DESCRIPTION OF THE DRAWINGS

FIG. 1 is a conceptual view of a communication system constituted by a plurality of communication apparatuses;

FIG. 2 is a conceptual view of a communication system constituted by a plurality of communication apparatuses;

FIG. 3 illustrates coupling between a transmitting coil 30 and a receiving coil 40 with equivalent circuits;

FIG. 4 is a conceptual view of a bias voltage in the receiving coil 40.

FIG. 5A illustrates wireless communication utilizing inductive coupling between coils;

FIG. 5B illustrates wireless communication utilizing inductive coupling between coils;

FIG. 5C illustrates wireless communication utilizing inductive coupling between coils;

FIG. 5D illustrates wireless communication utilizing inductive coupling between coils;

FIG. 5E illustrates wireless communication utilizing inductive coupling between coils;

FIG. 5F illustrates wireless communication utilizing inductive coupling between coils;

FIG. 6 shows an example of a frame format used by a semiconductor chip 1 to transmit and receive data;

FIG. 7 is a flowchart of processing by which a processor 10 of the semiconductor chip 1 receives data transmitted from another semiconductor chip 1;

FIG. 8 is a conceptual view of a wireless transmission collision;

FIG. 9 is a flowchart of processing by which the processor 10 of the semiconductor chip 1 detects a wireless transmission collision and transmits a retransmission request;

FIG. 10 shows an example of a frame format of a retransmission request;

FIG. 11 is a conceptual view of a plurality of retransmission requests transmitted sequentially;

FIG. 12 is a flowchart of processing by which the processor 10 of the semiconductor chip 1 transmits data and retransmits the same data in response to a retransmission request;

FIG. 13 is a block diagram showing a functional configuration of the semiconductor chip 1;

FIG. 14 shows an example of collisions involving wireless transmission addressed to other chips; and

FIG. 15 shows an example of collisions involving wireless transmission addressed to other chips.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

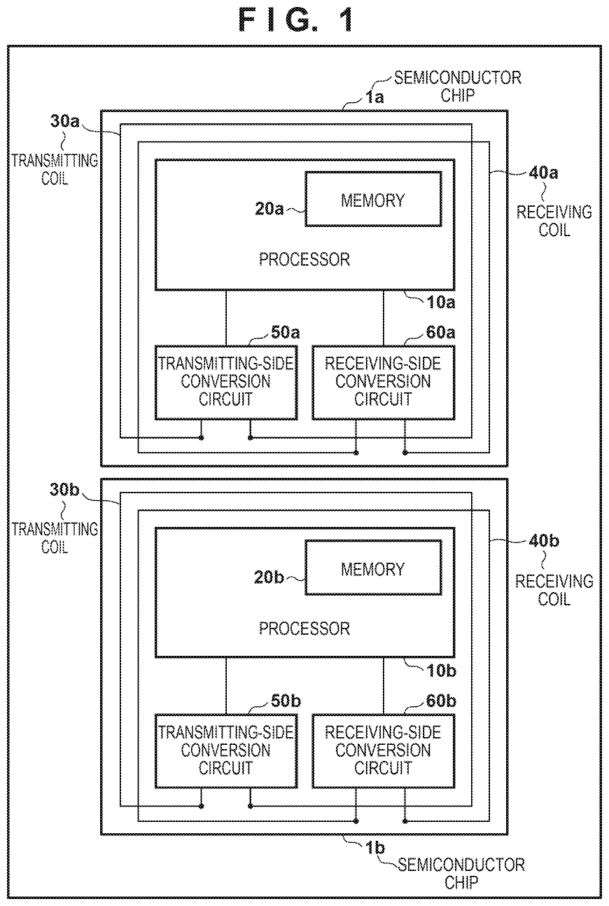

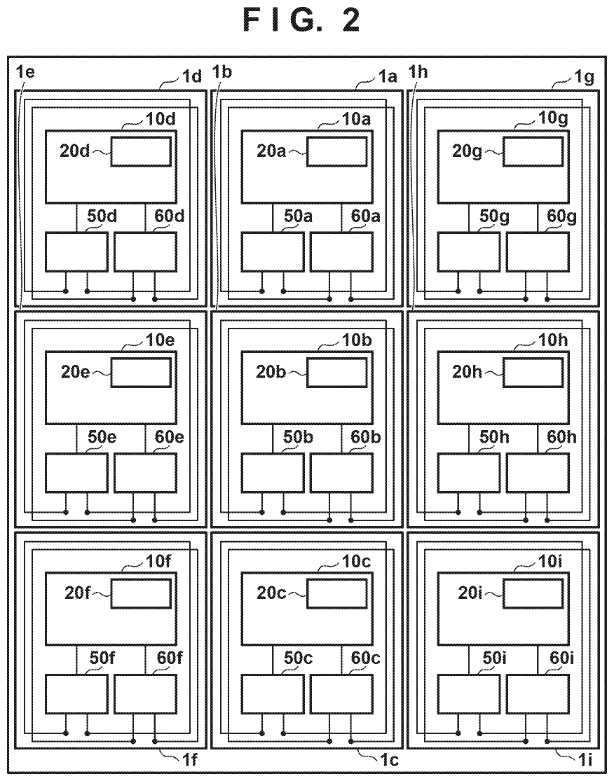

FIG. 1 is a conceptual view of a communication system constituted by a plurality of communication apparatuses. In the example shown in FIG. 1, the communication apparatuses are semiconductor chips. FIG. 1 shows two semiconductor chips (semiconductor chips 1a, 1b), but the number of semiconductor chips included in the communication system is not particularly limited. For example, as shown in FIG. 2, the communication system may include nine semiconductor chips (semiconductor chips 1a, 1b, 1c, 1d, 1e, 1f, 1g, 1h, 1i).

In the following description, in cases where it is not necessary to strictly distinguish between the semiconductor chips, “semiconductor chip 1” will be used as a general term for the semiconductor chips included in the communication system. In this case, the constituent elements of the semiconductor chips 1 shown in FIGS. 1 and 2 will also be described using general terms such as “processor 10”, for example, with the letters omitted from the reference signs.

The semiconductor chip 1 is provided with a processor 10, a memory 20 provided within the processor 10, a transmitting coil 30, a receiving coil 40, a transmitting-side conversion circuit 50, and a receiving-side conversion circuit 60. The semiconductor chip 1 operates with power supplied by a power supply apparatus not shown.

The processor 10 is, for example, a CPU, and performs various processing by executing programs. The memory 20 stores programs that are executed by the processor 10, various information that is used by the processor 10, and the like.

The transmitting-side conversion circuit 50 transmits data output from the processor 10 to another semiconductor chip 1 by wireless communication utilizing inductive coupling between the transmitting coil 30 of the semiconductor chip 1 and the receiving coil 40 of the other semiconductor chip 1. The receiving-side conversion circuit 60 receives data from another semiconductor chip 1 by wireless communication utilizing inductive coupling between the receiving coil 40 of the semiconductor chip 1 and the transmitting coil 30 of the other semiconductor chip 1. Note that “near-field inductive coupling”, “magnetic field coupling”, and “electromagnetic induction” may also be used as terms having the same meaning as “inductive coupling.”

### Equivalent Circuits of Transmitting Coil 30 and Receiving Coil 40

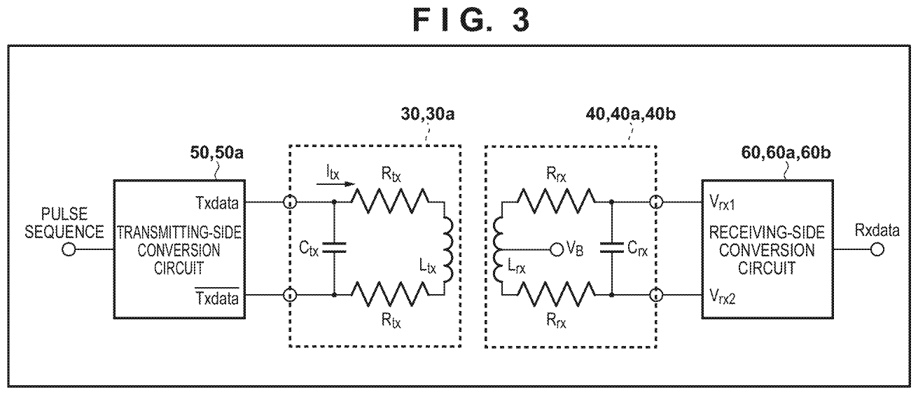

FIG. 3 illustrates coupling between the transmitting coil 30 and the receiving coil 40 with equivalent circuits. The transmitting coil 30 is represented by an equivalent circuit that includes an inductor Ltx, two resistors Rtx, and a capacitor Ctx. The receiving coil 40 is represented by an equivalent circuit that includes an inductor Lrx, two resistors Rrx, and a capacitor Crx.

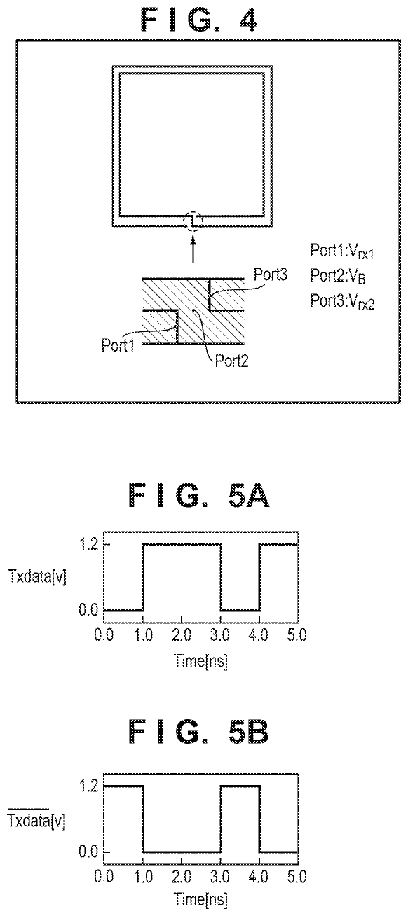

In the equivalent circuit of the receiving coil 40, a bias voltage V_{B} is applied to a midpoint of the inductor Lrx. This is realized by, for example, applying the bias voltage V_{B} to Port2, which is a midpoint of a two-turn coil, as shown in FIG. 4.

The transmitting coil 30 of a specific semiconductor chip 1 is coupled to the receiving coil 40 of each of the other one or more semiconductor chips 1 in close proximity thereto. In addition, the transmitting coil 30 of the specific semiconductor chip 1 is also coupled to the receiving coil 40 of the same semiconductor chip 1. Accordingly, for example, a transmitting coil 30a of the semiconductor chip 1a shown in FIG. 1 is coupled to a receiving coil 40b of the semiconductor chip 1b, and is also coupled to a receiving coil 40a of the semiconductor chip 1a. While coupling between any transmitting coil 30 and receiving coil 40 can be represented with the equivalent circuits shown in FIG. 3, the coupling coefficient changes according to the positional relationship (e.g., distance) between the transmitting coil 30 and the receiving coil 40.

In the communication system of FIG. 1, the semiconductor chip 1a and the semiconductor chip 1b are disposed in close proximity to each other, such that the coils are coupled between the semiconductor chip 1a and the semiconductor chip 1b. Also, in the communication system of FIG. 2, nine semiconductor chips 1 are disposed in a grid pattern, such that the coils are coupled in each combination of two semiconductor chips 1 adjacent in the up-down and left-right directions (e.g., combination of semiconductor chips 1a and 1b, combination of semiconductor chips 1b and 1e, etc.).

Identification information (ID) of each semiconductor chip 1 included in the communication system and information (coupling relationship information) indicating the coupling relationship between the semiconductor chips 1 in the communication system are stored in advance in the memory 20 of the semiconductor chip 1. Accordingly, the semiconductor chip 1 is able to identify other semiconductor chips 1 that are directly communicable therewith by inductive coupling in the communication system, by referring to the coupling relationship information. For example, in the communication system of FIG. 2, the semiconductor chip 1a is able to identify the semiconductor chips 1b, 1d, and 1g as other semiconductor chips 1 that are directly communicable with the semiconductor chip 1a, by referring to the coupling relationship information stored in a memory 20a.

### Wireless Communication Utilizing Inductive Coupling Between Coils

Wireless communication utilizing inductive coupling between coils will be described, taking the case where the semiconductor chip 1a transmits data to the semiconductor chip 1b in the communication system of FIG. 2 as an example. In this case, the transmitting-side conversion circuit 50 and the transmitting coil 30 shown in FIG. 3 respectively correspond to a transmitting-side conversion circuit 50a and the transmitting coil 30a of the semiconductor chip 1a. Also, the receiving-side conversion circuit 60 and the receiving coil 40 shown in FIG. 3 respectively correspond to a receiving-side conversion circuit 60b and the receiving coil 40b of the semiconductor chip 1b.

A processor 10a outputs a bit string representing data to be transmitted to the transmitting-side conversion circuit 50a as a digital signal (pulse sequence) represented by two voltages High and Low. The transmitting-side conversion circuit 50a performs waveform conversion processing that includes voltage conversion, pulse waveform shaping, and the like on the pulse sequence output from the processor 10a to generate Txdata and T̅x̅d̅a̅t̅a̅. In the following description, T̅x̅d̅a̅t̅a̅ may also be written as “Txdata (bar)”.

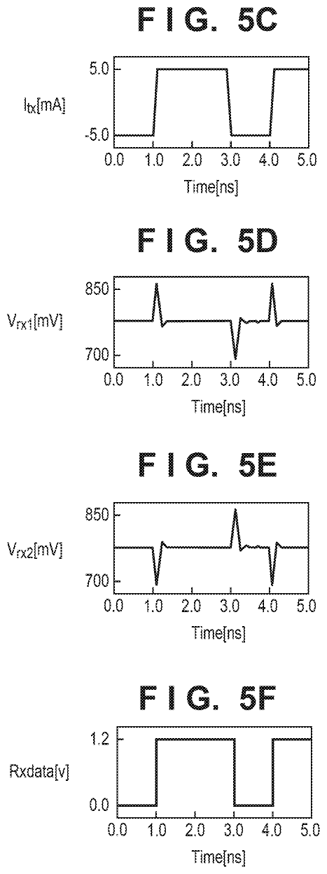

FIG. 5A shows an example of Txdata, and FIG. 5B shows an example of Txdata (bar). Txdata has the same pulse waveform as the pulse sequence output from the processor 10a. Txdata (bar) has a pulse waveform that inverts High and Low of Txdata. Note that, in the following description, the High voltage in the pulse sequence output from processor 10a and the High voltage in Txdata are both 1.2 V. However, the High voltage in the pulse sequence output from the processor 10a and the High voltage in Txdata may differ from each other.

The transmitting-side conversion circuit 50a applies voltages corresponding to Txdata and Txdata (bar) to the transmitting coil 30a. In the example shown in FIG. 3, the transmitting-side conversion circuit 50a is connected to the transmitting coil 30a such that Txdata is applied to an upper port of the transmitting coil 30a and Txdata (bar) is applied to a lower port thereof. If Txdata is High and Txdata (bar) is Low, a current Itx of the transmitting coil 30a flows in the direction from the upper side to the lower side of the inductor Ltx shown in FIG. 3. The current in this case corresponds to the period in which the value of Itx is 5.0 mA in FIG. 5C. On the other hand, if Txdata is Low and Txdata (bar) is High, the current Itx of the transmitting coil 30a flows in the direction from the lower side to the upper side of the inductor Ltx shown in FIG. 3. The current in this case corresponds to the period in which the value of Itx is −5.0 mA (period in which the polarity is inverted compared to the case where Txdata is High and Txdata (bar) is Low) in FIG. 5C.

Upon the current Itx flowing through the transmitting coil 30a, a voltage that depends on the transition of the current Itx is induced in the receiving coil 40b. The polarity of the induced voltage differs depending on whether the transition of the Txdata is from Low to High or from High to Low.

FIGS. 5D and 5E show examples of voltage waveforms induced in the receiving coil 40b. Vrx1 shown in FIG. 5D is a voltage observed at an upper port of the receiving coil 40b, and Vrx2 shown in FIG. 5E is a voltage observed at a lower port of the receiving coil 40b. Vrx1 changes in the positive direction due to an induced voltage corresponding to a rising edge of the waveform of the current Itx of the transmitting coil 30a, and changes in the negative direction due to an induced voltage corresponding to a falling edge of the waveform of the current Itx, centered around the bias voltage V_{B}. Vrx2 changes in the opposite direction to Vrx1 in response to the rising edge and the falling edge of the waveform of the current Itx of the transmitting coil 30a. The amplitudes of Vrx1 and Vrx2 are proportional to the magnitude of the current Itx and the coupling coefficient between the transmitting coil 30a and the receiving coil 40b.

The voltages Vrx1 and Vrx2 of the receiving coil 40b are input to the receiving-side conversion circuit 60b. A hysteresis comparator, for example, can be used as the receiving-side conversion circuit 60b. The receiving-side conversion circuit 60b generates a pulse sequence (Rxdata) represented by two values High and Low shown in FIG. 5F, based on the voltages Vrx1 and Vrx2. The pulse sequence generated by the receiving-side conversion circuit 60b has a waveform corresponding to the pulse sequence output by the processor 10a. The receiving-side conversion circuit 60b inputs the generated pulse sequence to a processor 10b. In this way, the processor 10b is able to acquire the pulse sequence (Rxdata) corresponding to the pulse sequence (transmission signal) output by the processor 10a, as a reception signal received via the receiving-side conversion circuit 60b.

The processor 10b is able to decode the pulse sequence input from the receiving-side conversion circuit 60b into a binary signal sequence (bit string) represented by 1 (High) or 0 (Low), by sampling the input pulse sequence at a predetermined sampling frequency. In the example shown in FIGS. 5A to 5F, the sampling frequency is 1 GHz (accordingly, the sampling period is 1 nanosecond (ns)) and the bit string “01101” is acquired.

In this way, the semiconductor chip 1a and the semiconductor chip 1b are able to transmit and receive data, by wireless communication utilizing inductive coupling between coils.

### Format of Frame for Data Transmission and Reception

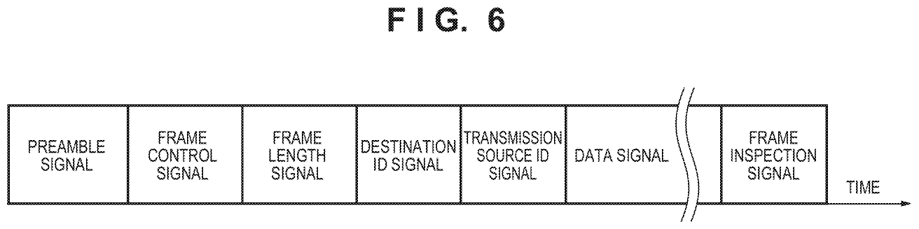

In transmission and reception of data between the semiconductor chips 1, a frame having a predetermined format can be used. FIG. 6 shows an example of a frame format used by the semiconductor chips 1 to transmit and receive data. In the example shown in FIG. 6, the frame has a format that includes a preamble signal, a frame control signal, a frame length signal, a destination ID signal, a transmission source ID signal, a data signal, and a frame inspection signal.

The preamble signal is constituted by a predetermined signal sequence (e.g., bit string having a specific pattern such as “101101”) that indicates the existence of a frame. The processor 10 of the semiconductor chip 1 is able to detect that another semiconductor chip 1 is transmitting a frame, by detecting the existence of a preamble signal.

The frame control signal is a signal that indicates the type of frame. Types of frames include “information frame”, “control frame”, “management frame”, “retransmission request frame,” and the like. The frame format after the frame control signal differs depending on the type of frame. FIG. 6 corresponds to the case where the type of frame is an information frame.

The frame length signal is a control signal that includes information of the length of the frame.

The destination ID signal indicates identification information (ID) of the semiconductor chip 1 to which the frame is addressed. For example, the destination ID signal of the frame that the semiconductor chip 1a transmits to the semiconductor chip 1b includes a bit string indicating the ID of the semiconductor chip 1b.

The transmission source ID signal indicates the ID of the semiconductor chip 1 that transmits the frame. For example, the transmission source ID signal of the frame that the semiconductor chip 1a transmits to the semiconductor chip 1b includes a bit string indicating the ID of the semiconductor chip 1a.

The data signal is a signal that includes the body of data (information) that is transmitted. The data signal may also include a sequence number indicating the order of the data signal.

The frame inspection signal is a signal for inspecting the received frame for errors. A cyclic redundancy check (CRC) code, for example, is used as the frame inspection signal. The semiconductor chip 1 completes reception of the frame with reception of the frame inspection signal.

### Data Transmission and Reception Between Semiconductor Chips 1

Data transmission and reception between the semiconductor chips 1 will be described, taking the case where the semiconductor chip 1a transmits data to the semiconductor chip 1b in the communication system of FIG. 2 as an example.

Data to be transmitted by the semiconductor chip 1a is stored in the memory 20a. Upon data to be transmitted to the semiconductor chip 1b being stored in the memory 20a of the semiconductor chip 1a, the processor 10a performs the following processing to create the frame described with reference to FIG. 6.
Set a predetermined bit string indicating the existence of a frame in “preamble signal”.
Set a bit string representing an “information frame” in “frame control signal”.
Calculate the frame length based on the amount of data to be transmitted and set a bit string representing the calculated frame length in “frame length signal”.
Set a bit string representing the ID of the semiconductor chip 1b, which is the destination of the data to be transmitted, in “destination ID signal”.
Set a bit string representing the ID of the semiconductor chip 1a in “transmission source ID signal”.
Set a bit string representing the data to be transmitted that is stored in the memory 20a in “data signal”. Note that processor 10a may set part, rather than all, of the data to be transmitted that is stored in the memory 20a in “data signal”. In other words, the processor 10a may divide the data and transmit the divided data with a plurality of frames.
Set a bit string for use in inspection (e.g., CRC code generated from the bit strings constituting the frame) in “frame inspection signal”.

The processor 10a outputs the bit strings of the frame as a digital signal (pulse sequence) represented by two voltages High and Low to the transmitting-side conversion circuit 50a.

As mentioned above, the transmitting-side conversion circuit 50a applies voltages corresponding to Txdata and Txdata (bar) that are generated based on the pulse sequence output from the processor 10a to the transmitting coil 30a. Upon the voltages being applied to the transmitting coil 30a, an induced voltage occurs in the receiving coil 40b. The receiving-side conversion circuit 60b generates a pulse sequence (Rxdata) having a waveform corresponding to the pulse sequence output by the processor 10a, based on Vrx1 and Vrx2, which vary according to the induced voltage, and inputs the generated pulse sequence (Rxdata) to the processor 10b.

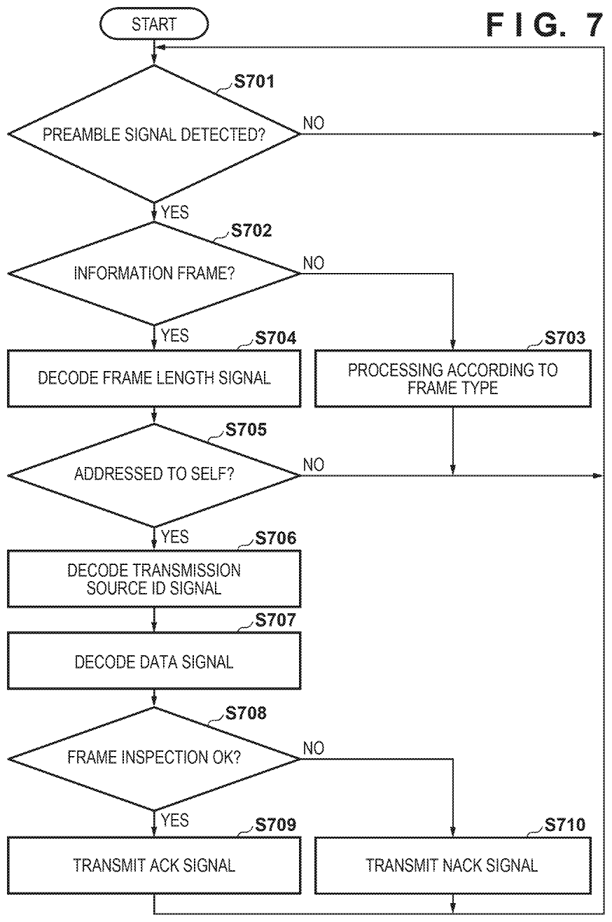

FIG. 7 is a flowchart of processing by which the processor 10 of the semiconductor chip 1 receives data transmitted from another semiconductor chip 1. Herein, the case where the semiconductor chip 1a transmits data to the semiconductor chip 1b in the communication system of FIG. 2 will be described as an example.

In step S701, the processor 10b of the semiconductor chip 1b determines whether a known preamble signal has been detected (i.e., whether another semiconductor chip 1 adjacent thereto is transmitting a frame). Specifically, the processor 10b compares a bit string obtained by decoding the pulse sequence (Rxdata) supplied from the receiving-side conversion circuit 60b at a predetermined sampling frequency with a known preamble signal, and determines that the known preamble signal was detected if the obtained bit string matches the known preamble signal. The processor 10b repeats the processing of step S701 until a preamble signal is detected. Upon a preamble signal being detected, the processing proceeds to step S702.

In step S702, the processor 10b decodes the frame control signal that follows the preamble signal and determines whether the frame type is an information frame. If the frame type is an information frame, the processing proceeds to step S704, and, if that is not the case, the processing proceeds to step S703.

In step S703, the processor 10b performs processing that depends on the frame type as appropriate. Thereafter, the processing returns to step S701.

In step S704, the processor 10b decodes the frame length signal and confirms the frame length.

In step S705, the processor 10b decodes the destination ID signal and determines whether the frame is addressed thereto (whether the destination ID is the ID of semiconductor chip 1b). If the frame is addressed thereto, the processing proceeds to step S706, and, if that is not the case, the processing returns to step S701.

In step S706, the processor 10b decodes the transmission source ID signal and acquires the ID of the semiconductor chip 1 that is the transmission source of the frame. If the semiconductor chip 1a is the transmission source of the frame, the ID of the semiconductor chip 1a is acquired.

In step S707, the processor 10b decodes the data signal and acquires the body of the transmitted data.

In step S708, the processor 10b decodes the frame inspection signal and determines whether the frame was received without error. If the frame was received without error (if the result of frame inspection is OK), the processing proceeds to step S709, and, if that is not the case, the processing proceeds to step S710.

In step S709, the processor 10b transmits an Acknowledgement (ACK) signal to the semiconductor chip 1a, which is the transmission source of the frame, via the transmitting-side conversion circuit 50b. Thereafter, the processing returns to step S701.

In step S710, the processor 10b transmits a Negative ACK (NACK) signal to the semiconductor chip 1a, which is the transmission source of the frame, via the transmitting-side conversion circuit 50b. Thereafter, the processing returns to step S701.

### Occurrence of Wireless Transmission Collision

As described with reference to FIGS. 5D and 5E, when the semiconductor chip 1a performs wireless transmission to the semiconductor chip 1b in the communication system of FIG. 2, voltages corresponding to the transmission signals of the semiconductor chip 1a are induced in the receiving coil 40b of the semiconductor chip 1b. Herein, the case where the semiconductor chip 1b performs wireless transmission to the semiconductor chip 1a, 1c, 1e, or 1h while the semiconductor chip 1a is performing wireless transmission will be considered. In this case, the receiving coil 40b of the semiconductor chip 1b is also inductively coupled to the transmitting coil 30b, and thus voltages corresponding to the transmission signals from the semiconductor chip 1b itself are also induced in the receiving coil 40b. Such a phenomenon (phenomenon where voltages corresponding to a plurality of transmission signals transmitted at the same time are induced in a specific receiving coil 40) is called a “wireless transmission collision” or a “wireless communication collision”, or simply a “collision”.

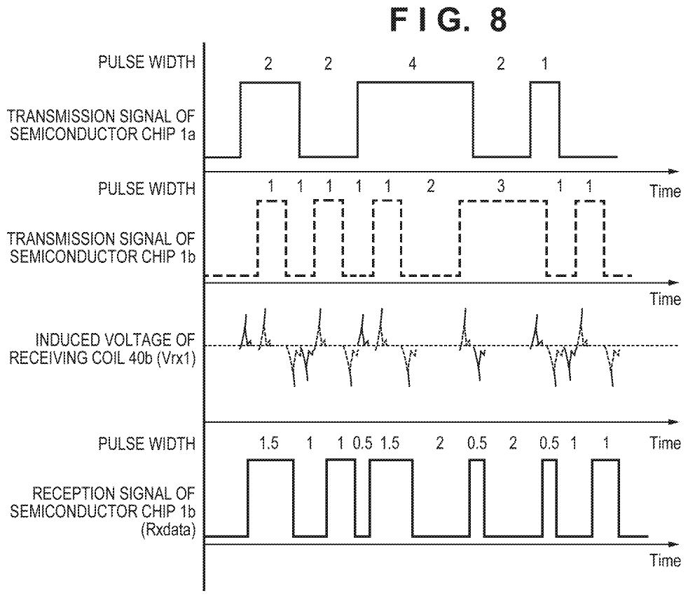

FIG. 8 is a conceptual view of a wireless transmission collision. In FIG. 8, the numerical values of the pulse widths represent pulse widths in the case where 1 is a pulse width (hereinafter, “unit pulse width”) corresponding to the period of one cycle (hereinafter, “1-bit period”) of the sampling frequency for decoding reception signals. Accordingly, the numerical values of the pulse widths correspond to the number of bits included in the corresponding pulse. In the example described with reference to FIGS. 5A to 5F, the sampling frequency is 1 GHz and the 1-bit period is 1 ns.

In FIG. 8, voltage pulses (Txdata and Txdata (bar)) generated by the transmitting-side conversion circuit 50a based on the transmission signal represented by the solid line are applied to the transmitting coil 30a of the semiconductor chip 1a. As a result, an induced voltage represented by the solid line is observed at the upper port of the receiving coil 40b of the semiconductor chip 1b (see FIG. 3). Similarly, voltage pulses (Txdata and Txdata (bar)) generated by the transmitting-side conversion circuit 50b based on the transmission signal represented by the dashed line are applied to the transmitting coil 30b of the semiconductor chip 1b. As a result, an induced voltage represented by the dashed line is also observed at the upper port of the receiving coil 40b of the semiconductor chip 1b. Note that while Vrx2 observed at the lower port of the receiving coil 40b (see FIG. 3) is omitted in FIG. 8, induced voltages corresponding to both the transmission signal represented by the solid line and the transmission signal represented by the dashed line are also observed at the lower port, similarly to the upper port (however, the induced voltages at the upper and lower ports are opposite in polarity).

As shown in FIG. 8, when induced voltages corresponding to two transmission signals occur in the receiving coil 40b, the pulse waveform of the reception signal (Rxdata) generated by the receiving-side conversion circuit 60b will have a shape different from either of the two transmission signals. Thus, when a collision occurs, the processor 10b is unable to correctly receive (decode) data transmitted by the semiconductor chip 1a.

In this way, when a specific semiconductor chip 1 (semiconductor chip 1b in the example shown in FIG. 8) and a semiconductor chip 1 adjacent thereto (semiconductor chip 1a in the example shown in FIG. 8) perform wireless transmission at the same time, a wireless transmission collision occurs.

A wireless transmission collision also occurs when a plurality of semiconductor chips 1 adjacent to a specific semiconductor chip 1 perform wireless transmission at the same time. Consider the case where, for example, the semiconductor chip 1c also performs wireless transmission to the semiconductor chip 1b while the semiconductor chip 1a is performing wireless transmission to the semiconductor chip 1b in the communication system of FIG. 2. In order to describe the collision that occurs in this case, the transmission signal of the semiconductor chip 1b shown in FIG. 8 should be taken as the transmission signal of the semiconductor chip 1c. It can then be seen that the induced voltage, represented by the solid line, corresponding to the transmission signal of the semiconductor chip 1a and the induced voltage, represented by the dashed line, corresponding to the transmission signal of the semiconductor chip 1c occur in the receiving coil 40b (amplitude of the induced voltage corresponding to the transmission signal of semiconductor chip 1c is, however, determined according to the coupling coefficient between receiving coil 40b and transmitting coil 30c, and is thus not necessarily the same as the amplitude of the induced voltage corresponding to the transmission signal of semiconductor chip 1b). Also, it can be seen that the pulse waveform of the reception signal (Rxdata) generated by the receiving-side conversion circuit 60b has a different shape to both of the two transmission signals. Thus, when a collision occurs, the processor 10b is unable to correctly receive (decode) either data transmitted by the semiconductor chip 1a or data transmitted by the semiconductor chip 1c.

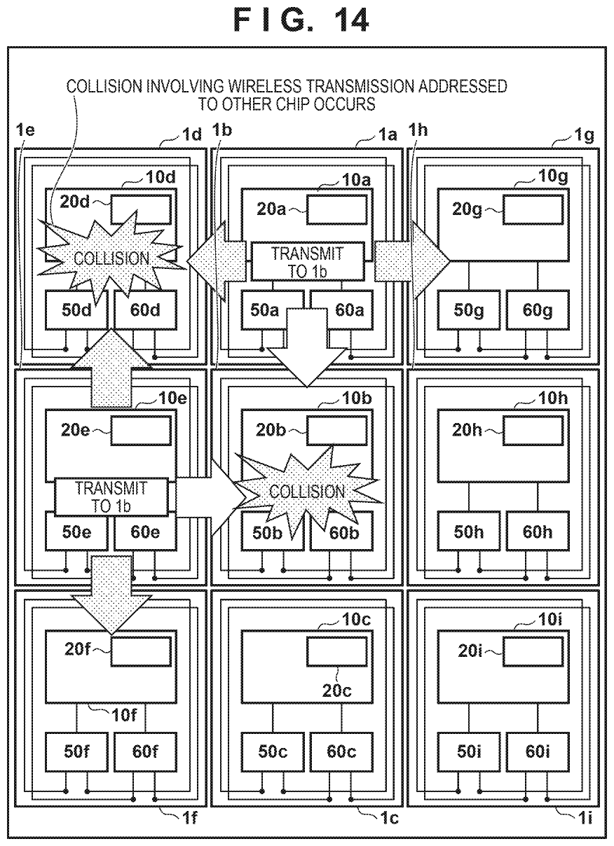

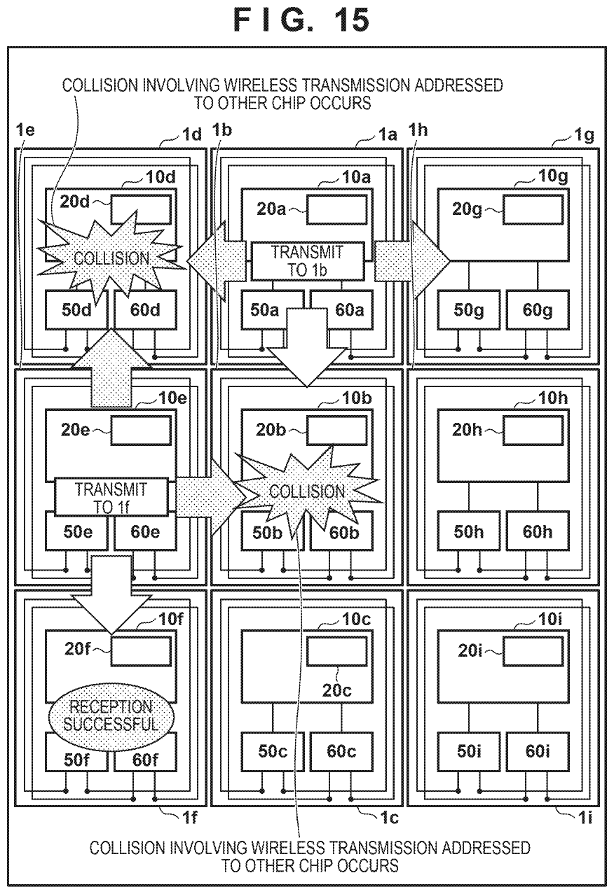

Also, as shown in FIGS. 14 and 15, a collision involving wireless transmission addressed to other chips may occur in the semiconductor chip 1. In the example shown in FIG. 14, the semiconductor chip 1e is also performing wireless transmission to the semiconductor chip 1b, while the semiconductor chip 1a is performing wireless transmission to the semiconductor chip 1b. The transmitting coil 30a of the semiconductor chip 1a is also inductively coupled to a receiving coil 40d of the semiconductor chip 1d, and a transmitting coil 30e of the semiconductor chip 1e is also inductively coupled to the receiving coil 40d of the semiconductor chip 1d. Thus, voltages corresponding to the two transmission signals addressed to another chip (semiconductor chip 1b) are induced in the receiving coil 40d of the semiconductor chip 1d, resulting in a collision.

In the example shown in FIG. 15, the semiconductor chip 1e is performing wireless transmission to the semiconductor chip 1f, while the semiconductor chip 1a is performing wireless transmission to the semiconductor chip 1b. The transmitting coil 30a of the semiconductor chip 1a is also inductively coupled to the receiving coil 40d of the semiconductor chip 1d, and the transmitting coil 30e of the semiconductor chip 1e is also inductively coupled to the receiving coil 40d of the semiconductor chip 1d. Thus, voltages corresponding to the two transmission signals addressed to other chips (transmission signal addressed to semiconductor chip 1b and transmission signal addressed to semiconductor chip 1f) are induced in the receiving coil 40d of the semiconductor chip 1d, resulting in a collision. Further, the transmitting coil 30e of the semiconductor chip 1e is also inductively coupled to the receiving coil 40b of the semiconductor chip 1b. Thus, in addition to the voltage corresponding to the transmission signal addressed thereto (addressed to the semiconductor chip 1b) from the semiconductor chip 1a, a voltage corresponding to the transmission signal addressed to another chip (addressed to the semiconductor chip 1f) from the semiconductor chip 1e is also induced in the receiving coil 40b of the semiconductor chip 1b, resulting in a collision.

### Collision Detection and Transmission of Retransmission Request

As methods for detecting the occurrence of a wireless transmission collision, a method that is based on the frequency of the reception signal (pulse sequence), a method that is based on the pulse width of the reception signal (pulse sequence), and a method that is based on a bit error in the reception signal (pulse sequence) will be described.

First, the method that is based on the frequency of the reception signal (pulse sequence) will be described. As can be seen from FIG. 8, when a collision occurs, pulses smaller than the unit pulse width may occur, and, as a result, the frequency of the pulse sequence may become greater than the sampling frequency for decoding the pulse sequence. In view of this, the processor 10 is able to determine whether a collision has occurred by measuring the frequency of the pulse sequence and determining whether the frequency of the pulse sequence is higher than the sampling frequency. If the frequency of the pulse sequence is higher than the sampling frequency, the processor 10 determines that a collision has occurred (i.e., detects a collision).

In order to measure the frequency of the pulse sequence, the processor 10 samples the pulse sequence at a frequency higher than (e.g., 8 times) the sampling frequency for decoding the pulse sequence. The processor 10 is thereby able to identify the High periods and Low periods in the pulse sequence at a high resolution, and is thus able to calculate the frequency of the pulse sequence by counting the number of pulses within a predetermined time period.

Next, the method that is based on the pulse width of the reception signal (pulse sequence) will be described. As can be seen from FIG. 8, when a collision occurs, pulses having a width different from an integer multiple of the unit pulse width, such as “0.5” and “1.5”, may occur. In view of this, the processor 10 is able to determine whether a collision has occurred by determining whether a pulse having a width different from an integer multiple of the unit pulse width is included in the pulse sequence. If the pulse sequence includes a pulse having a width different from an integer multiple of the unit pulse width, the processor 10 determines that a collision has occurred.

Note that processor 10 samples the pulse sequence at a high frequency similarly to when using the method that is based on the frequency of the reception signal (pulse sequence), and identifies the High periods and Low periods in the pulse sequence at a high resolution. The width of each pulse included in the pulse sequence can thereby be determined.

Finally, the method that is based on a bit error in the reception signal (pulse sequence) will be described. If a collision occurs after a preamble signal is detected in step S701 of FIG. 7, a bit error occurs in the portion of the frame after the preamble signal. As a result, an error (i.e., bit error in the reception signal) in the frame is detected in the frame inspection of step S708 of FIG. 7. In view of this, the processor 10 is able to determine whether a collision has occurred by determining whether a bit error has occurred in the reception signal, based on the result of the frame inspection of step S708. If a bit error occurs in the reception signal, the processor 10 determines that a collision has occurred.

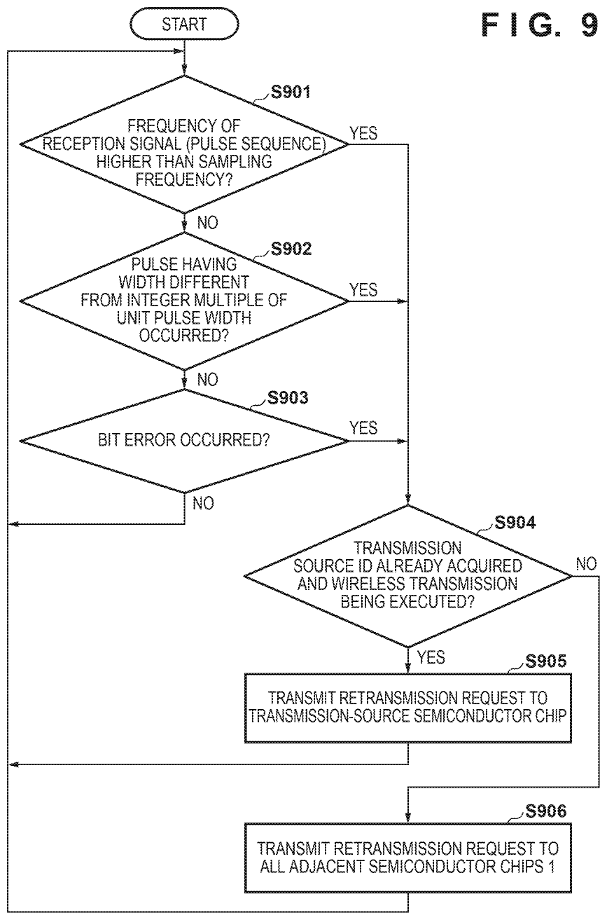

FIG. 9 is a flowchart of processing by which the processor 10 of the semiconductor chip 1 detects a wireless transmission collision and transmits a retransmission request. The processing in FIG. 9 is executed in parallel with the processing in FIG. 7 (processing for receiving data). Herein, the case where the semiconductor chip 1a transmits data to the semiconductor chip 1b in the communication system of FIG. 2 will be described.

In step S901, the processor 10b measures the frequency of the reception signal (pulse sequence) and determines whether the frequency of the pulse sequence is higher than the sampling frequency. If the frequency of the pulse sequence is higher than the sampling frequency, the processing proceeds to step S904, and, if that is not the case, the processing proceeds to step S902. Note that, in order to suppress the case where a small increase in the frequency of the pulse sequence due to measurement error or the like is erroneously detected as the occurrence of a collision, a threshold (e.g., 1.2 times the sampling frequency) for determining that the frequency of the pulse sequence is higher than the sampling frequency may be set. In this case, if the measured frequency of the pulse sequence is greater than or equal to the threshold, the processor 10b advances the processing to step S904.

In step S902, the processor 10b determines whether the pulse sequence includes a pulse having a different width from an integer multiple of the unit pulse width (whether a pulse having a different width from an integer multiple of the unit pulse width has occurred). If a pulse having a different width from an integer multiple of the unit pulse width has occurred, the processing proceeds to step S904, and, if that is not the case, the processing proceeds to step S903. Note that, in order to suppress the case where a small variation in the pulse width due to measurement error or the like is erroneously detected as the occurrence of a collision, a threshold (e.g., 0.2 if the unit pulse width is set as 1) for determining that the measured pulse width is different from an integer multiple of the unit pulse width may be provided. In this case, if the decimal portion of the measured pulse width is from 0.2 or more to 0.8 or less, the processor 10b advances the processing to step S904.

In step S903, the processor 10b determines whether there is a bit error in the reception signal. If there is a bit error in the reception signal, the processing proceeds to step S904, and, if that is not the case, the processing returns to step S901. Accordingly, while no collision has occurred, the processor 10b continues to monitor for a collision, by repeatedly executing steps S901 to S903.

In step S904, the processor 10b determines whether the transmission source ID (transmission source identification information) has been acquired from the reception signal and whether the subject semiconductor chip 1b is executing wireless transmission. If the transmission source ID has been acquired from the reception signal and the subject semiconductor chip 1b is executing wireless transmission, the processing proceeds to step S905, and, if that is not the case, the processing proceeds to step S906.

Note that the transmission source ID having been acquired from the reception signal in step S904 means that the collision occurred after the transmission source ID signal was decoded in step S706 of the processing in FIG. 7, which is executed in parallel with the processing in FIG. 9. Herein, since the case where the semiconductor chip 1a transmits data to the semiconductor chip 1b is being described as an example, the ID of the semiconductor chip 1a is acquired.

In step S905, the processor 10b transmits a retransmission request to the semiconductor chip 1a that is identified by the acquired transmission source ID, via the transmitting-side conversion circuit 50b. Thereafter, the processing returns to step S901. The frame format of the retransmission request used herein will be described later.

In step S906, the processor 10b transmits a retransmission request to all adjacent semiconductor chips 1, via the transmitting-side conversion circuit 50b. Thereafter, the processing returns to step S901. The frame format of the retransmission request used herein will be described later.

Note that if the transmission source ID (transmission source identification information) has already been acquired from the reception signal at the time of the collision and the subject semiconductor chip 1 is executing wireless transmission, it is conceivable that wireless transmission of the subject semiconductor chip 1 has collided with wireless transmission of the semiconductor chip 1 indicated by the transmission source ID. Thus, as described in step S905, retransmission of data that could not be correctly received due to the collision can be requested, by transmitting a retransmission request to the semiconductor chip 1 indicated by the transmission source ID. However, even in this case, wireless transmission of another semiconductor chip 1 different from the semiconductor chip 1 indicated by the transmission source ID may be involved in the collision. In this case, a retransmission request cannot be made to the other semiconductor chip 1 with the processing of step S905. In view of this, a configuration may be adopted in which, in the case of a collision, the processing of step S906 is performed (processing for transmitting a retransmission request to all semiconductor chips 1 adjacent to the subject semiconductor chip 1) regardless of whether the transmission source ID (transmission source identification information) has been acquired, and regardless of whether the subject semiconductor chip 1 is executing wireless transmission.

Incidentally, if collisions are detected in a plurality of semiconductor chips 1 at the same time (or at substantially the same time), there is a possibility that a collision will occur between a plurality of retransmission requests transmitted by these semiconductor chips 1. For example, if a collision occurs in a manner such as described above with reference to FIGS. 14 and 15, there is a possibility that the retransmission request transmitted by the semiconductor chip 1b and the retransmission request transmitted by the semiconductor chip 1d will collide in the semiconductor chips 1a and 1e. In order to reduce this possibility, the processor 10 of each semiconductor chip 1 may wait temporarily before transmitting the retransmission request in step S905 or step S906. The waiting time is determined by, for example, a random number generated using the ID of the semiconductor chip 1 as a seed. The timing of transmission thereby changes for each semiconductor chip 1 in the case where a plurality of semiconductor chips 1 transmit retransmission requests in the communication system, thus enabling the possibility of collisions to be reduced.

Note that the IDs of the semiconductor chips 1 are fixed in the communication system, and thus if random numbers generated using the IDs of the semiconductor chips 1 as seeds are used as the waiting times, the waiting times of the semiconductor chips 1 are also fixed. Thus, there is unfairness among the semiconductor chips 1 regarding the lengths of the waiting times. In view of this, in order to determine the waiting times more fairly, a method that is based on the value of a collision detection counter may be used.

When using the method that is based on the value of a collision detection counter, the processor 10 of each semiconductor chip 1 is internally provided with a counter (collision detection counter) for counting the number of times a collision is detected. In this case, the processor 10 is able to determine the waiting time using a random number generated using the value of the collision detection counter within the processor 10 as a seed. Alternatively, the processor 10 may determine the waiting time such that the waiting time is longer as the remainder of dividing the random number r generated using the ID of the subject semiconductor chip 1 as a seed by the value c of the collision detection counter (r mod c) increases. For example, consider the case where the random number r is an integer in a range from 0 to 255. In this case, if the value of the collision detection counter is 10, the remainder (r mod 10) will be an integer in a range from 0 to 9, and if the value of the collision detection counter is 3, the remainder (r mod 3) will be an integer in a range from 0 to 2. In this way, the possible maximum value of the remainder increases and the possible maximum value of the waiting time increases as the number of detected collisions increases. Thus, it is possible to effectively reduce the possibility of collisions occurring again due to transmission of retransmission requests.

### Frame Format of Retransmission Request

The format shown in FIG. 6 can be used as the frame format of the retransmission request that is transmitted in step S905. In this case, a bit string representing a “retransmission request frame” is set in the frame control signal. Also, a bit string representing the transmission source ID (herein, ID of semiconductor chip 1a) that was acquired in step S706 of FIG. 7 is set in the destination ID signal. Also, the data signal can be omitted. However, a bit string indicating a sequence number may be set in the data signal. In this case, a retransmission request designating a frame of a specific sequence as the retransmission target can be transmitted.

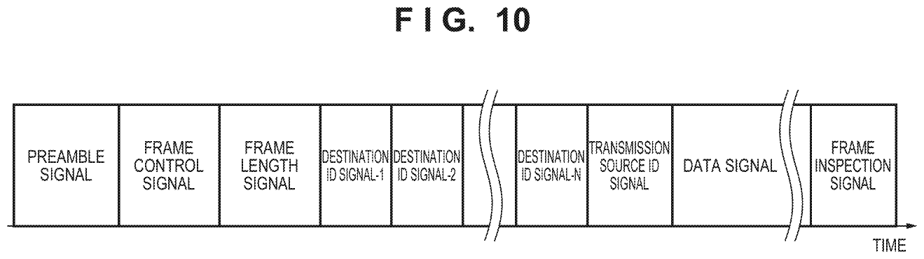

The format shown in FIG. 10 or the format shown in FIG. 6 can be used as the frame format of the retransmission request that is transmitted in step S906.

The format shown in FIG. 10 differs from the format shown in FIG. 6 in that the same number of destination ID signals as the number of adjacent semiconductor chips 1 are included. For example, when the semiconductor chip 1b transmits a retransmission request in the communication system of FIG. 2, the retransmission request frame includes four destination ID signals. Bit strings indicating the IDs of the four adjacent semiconductor chips 1a, 1c, 1e, and 1h are respectively set in the four destination ID signals. The signal portion other than the destination ID signals is similar to the retransmission request that is transmitted in step S905.

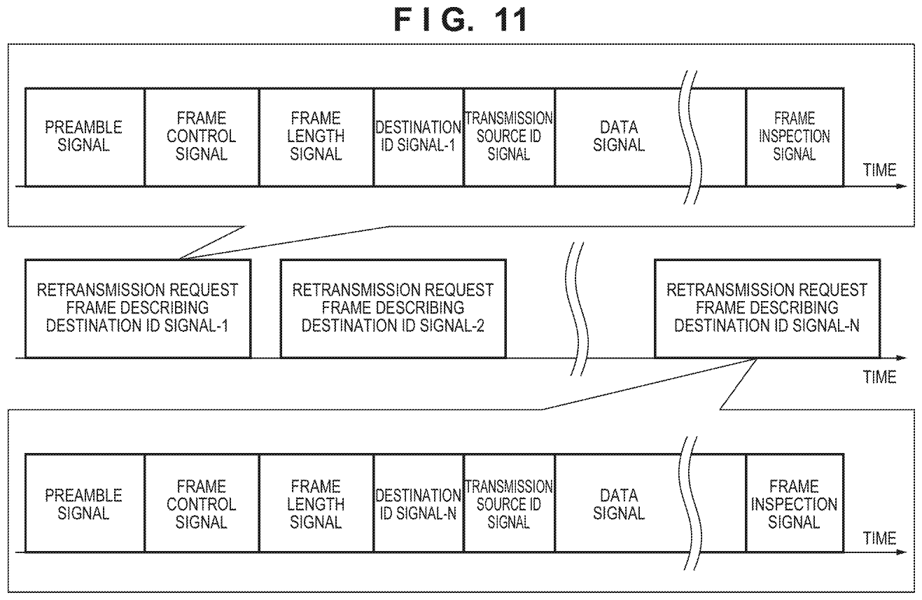

When using the format shown in FIG. 6, there is a method that involves broadcasting a retransmission request and a method that involves sequentially transmitting a plurality of retransmission requests as shown in FIG. 11.

With the method that involves broadcasting a retransmission request, an ID indicating a broadcast is set in the destination ID signal. The signal portion other than the destination ID signal is similar to the retransmission request that is transmitted in step S905.

With the method that involves sequentially transmitting a plurality of retransmission requests as shown in FIG. 11, the same number of retransmission request frames as the number of adjacent semiconductor chips 1 are sequentially transmitted. For example, in the case where the semiconductor chip 1b transmits a retransmission request in the communication system of FIG. 2, the processor 10b of the semiconductor chip 1b sequentially transmits four retransmission request frames. Bit strings indicating the IDs of the four adjacent semiconductor chips 1a, 1c, 1e, and 1h are respectively set in the destination ID signals of the four retransmission request frames. Also, retransmission request frame numbers are respectively set in descending order, such as “N”, “N−1”, “ . . . ”, “2”, “1”, in the data signals of the retransmission request frames. The semiconductor chip 1 that receives a retransmission request frame is able to know how many more retransmission request frames will be transmitted by referring to the retransmission request frame number. The signal portion other than the destination ID signal and the data signal is similar to the retransmission request transmitted in step S905. Also, bit strings indicating sequence numbers may be set in the data signals, similarly to the retransmission request that is transmitted in step S905.

Note that if a collision is detected with the method (see step S903 in FIG. 9) that is based on a bit error in the reception signal (pulse sequence), a NACK signal is transmitted (see step S710 in FIG. 7). In this case, the processor 10 may treat the NACK signal as a retransmission request. In other words, transmission of a NACK signal by the processor 10 in step S710 is equivalent to transmission of a retransmission request.

### Transmission and Retransmission of Data

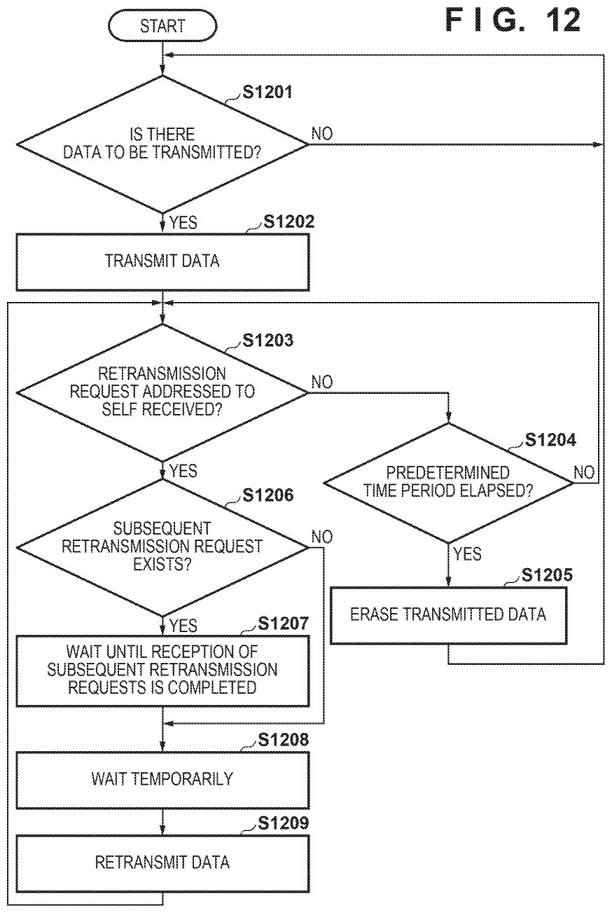

FIG. 12 is a flowchart of processing by which the processor 10 of the semiconductor chip 1 transmits data and retransmits the same data in response to a retransmission request. Herein, the case where the semiconductor chip 1a transmits data to the semiconductor chip 1b in the communication system of FIG. 2 will be described as an example.

In step S1201, the processor 10a determines whether there is data to be transmitted. As mentioned above, data that is transmitted by the semiconductor chip 1a is stored in the memory 20a. The processor 10a repeats the determination of step S1201 until there is data to be transmitted (until data to be transmitted is stored in memory 20a). Upon there being data to be transmitted, the processing proceeds to step S1202.

In step S1202, the processor 10a transmits the data to the semiconductor chip 1b using the frame described with reference to FIG. 6.

In step S1203, the processor 10a determines whether a retransmission request addressed to the semiconductor chip 1a has been received. Reception of a retransmission request is performed by similar processing to the processing for receiving data described with reference to FIG. 7. That is, when it is determined that the frame type is a retransmission request frame in step S702 of FIG. 7, the remaining portion of the frame is decoded by similar processing to steps S704 to S708. If the decoding result indicates that the frame is addressed to the semiconductor chip 1a and the frame is error free, the processor 10a determines that a retransmission request addressed to the semiconductor chip 1a has been received. If a retransmission request addressed to the semiconductor chip 1a has been received, the processing proceeds to step S1206, and, if that is not the case, the processing proceeds to step S1204.

In step S1204, the processor 10a determines whether a predetermined time period has elapsed. If the predetermined time period has elapsed, the processing proceeds to step S1205, and, if that is not the case, the processing returns to step S1203.

In step S1205, the processor 10a erases the data transmitted in step S1202 from the memory 20a. Thereafter, the processing returns to step S1201. As a result of the processing of steps S1203 to S1205, the processor 10a is able to determine that data transmission was successful and erase the transmitted data, if a retransmission request is not received within the predetermined time period from data transmission. Note that if an ACK signal is received, the processor 10a may erase the transmitted data, even before the predetermined time period has elapsed.

In step S1206, the processor 10a determines whether there is a subsequent retransmission request. As described with reference to FIG. 11, when a plurality of retransmission requests are transmitted, retransmission request frame numbers are respectively set in descending order in the data signals of the retransmission request frames. If the retransmission request frame number set in the data signal of the received retransmission request frame is “2” or higher, the processor 10a determines that there is a subsequent retransmission request. If there is a subsequent retransmission request, the processing proceeds to step S1207, and, if that is not the case, the processing proceeds to step S1208.

In step S1207, the processor 10a waits until all subsequent retransmission requests are received. The possibility of collisions between retransmission of data and subsequent retransmission requests can thereby be reduced.

In step S1208, the processor 10a waits temporarily. The waiting time is determined by, for example, a random number generated using the ID of the semiconductor chip 1a as a seed. The timing of retransmission thereby changes for each semiconductor chip 1 in the case where a plurality of semiconductor chips 1 retransmit data in the communication system, thus enabling the possibility of collisions to be reduced.

Note that the IDs of the semiconductor chips 1 are fixed in the communication system, and thus if random numbers generated using the IDs of the semiconductor chips 1 as seeds are used as the waiting times, the waiting times of the semiconductor chips 1 are also fixed. Thus, there is unfairness among the semiconductor chips 1 regarding the lengths of the waiting times. In view of this, in order to determine the waiting times more fairly, a method that is based on the order of the destination ID signals in a retransmission request frame or a method that is based on the value of a retransmission request reception counter may be used.

The method that is based on the order of the destination ID signals in a retransmission request frame can be used if the retransmission request frame have the format shown in FIG. 10. In this case, the processor 10a is able to determine the waiting time based on the order, within a retransmission request frame, of the destination ID signal in which the ID of the subject semiconductor chip 1a is included. For example, if the ID of the semiconductor chip 1a is included in the second destination ID signal (“Destination ID Signal-2” shown in FIG. 10) within a retransmission request frame, the processor 10a may determine the waiting time as (2×t) nanoseconds (where t is a predetermined constant). Alternatively, the processor 10a may determine the waiting time by a random number generated using, as a seed, the order, within a retransmission request frame, of the destination ID signal in which the ID of the subject semiconductor chip 1a is included.

When using the method that is based on the value of a retransmission request reception counter, the processor 10 of each semiconductor chip 1 is internally provided with a counter (retransmission request reception counter) for counting the number of times a retransmission request is received. This method is similar to the “method that is based on the value of a collision detection counter” described above in relation to steps S905 and S906, except that a retransmission request reception counter is used instead of a collision detection counter.

In step S1209, the processor 10a retransmits the same data as the data transmitted in step S1202. Thereafter, the processing returns to step S1203. Accordingly, when retransmitting data, similarly to when first transmitting the data, the processor 10a is able to determine that data transmission (retransmission) was successful and erase the transmitted data, if a retransmission request is not received within a predetermined time period from data transmission.

Note that a retransmission request addressed to a semiconductor chip 1 other than the semiconductor chip 1a (e.g., retransmission request transmitted by semiconductor chip 1b addressed to semiconductor chip 1e) may be received while the processor 10a is repeatedly performing the determination of step S1201. In this case, the processor 10a may perform control to temporarily refrain from performing wireless transmission. Specifically, for example, the processor 10a temporarily suspends repetition of the determination of step S1201. While repetition of the determination of step S1201 is suspended, the processing does not proceed to step S1202 even if there is data to be transmitted. Thus, transmission of data in step S1202 is not performed, and wireless transmission is temporarily put on hold. By performing such control, the possibility of a collision between transmission of data by the semiconductor chip 1a and retransmission of data by the semiconductor chip 1 other than the semiconductor chip 1a can be reduced.

Incidentally, there are cases where a specific semiconductor chip 1 receives a retransmission request addressed thereto from a semiconductor chip 1 that is different from the destination to which the transmitted data (data transmitted by the processor 10 in step S1202) was addressed. For example, if a collision occurs in a manner such as described above with reference to FIGS. 14 and 15, the semiconductor chip 1a receives a retransmission request addressed thereto from the semiconductor chip 1d, in addition to a retransmission request addressed thereto from the semiconductor chip 1b. In this case, the processor 10a needs to perform retransmission addressed to the semiconductor chip 1b, but does not need to perform retransmission addressed to the semiconductor chip 1d (transmitted data to be retransmitted to the semiconductor chip 1d does not exist in the first place). Also, in FIG. 15, the semiconductor chip 1e receives retransmission requests addressed thereto from the semiconductor chips 1b and 1d. However, since transmitted data to be retransmitted to the semiconductor chips 1b and 1d does not exist, and data transmission from the semiconductor chip 1e to the semiconductor chip 1f was successful, the processor 10e does not need to retransmit transmitted data to any of the semiconductor chips 1. In view of this, step S1203 may be configured to determine whether a “retransmission request addressed thereto from the chip to which data was transmitted in step S1202” has been received. The transmission source of a retransmission request can be determined based on the transmission source ID signal within the retransmission request frame. If a “retransmission request addressed thereto from the chip to which data was transmitted in step S1202” has been received, the processing proceeds from step S1203 to step S1206, and, if that is not the case, the processing proceeds from step S1203 to step S1204. In the case where such a configuration is adopted, even if, for example, the semiconductor chip 1e shown in FIG. 15 receives retransmission requests addressed thereto from the semiconductor chips 1b and 1d, the processor 10e determines that a “retransmission request addressed thereto from the chip to which data was transmitted in step S1202” has not been received. Thus, it is possible to avoid the processing of steps S1206 to S1208 being executed unnecessarily even though data to be retransmitted in step S1209 does not exist.

### Functional Configuration of Semiconductor Chip 1

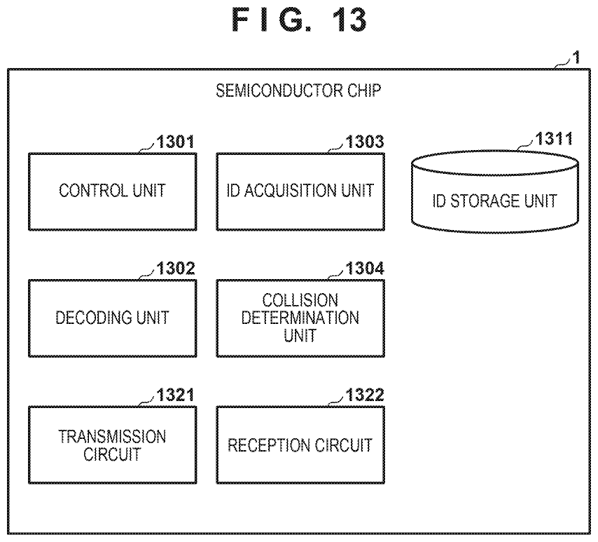

FIG. 13 is a block diagram showing the functional configuration of the semiconductor chip 1. In FIG. 13, a control unit 1301, a decoding unit 1302, an ID acquisition unit 1303, and a collision determination unit 1304 are realized by the processor 10 executing a program stored in the memory 20.

The control unit 1301 performs various types of control related to wireless communication by the semiconductor chip 1. The various types of control referred to herein include control of processing for receiving data (FIG. 7), control of processing for transmitting a retransmission request when a collision occurs (FIG. 9 (particularly steps S904 to S906)), and control of processing for transmitting data and retransmitting the same data in response to a retransmission request (FIG. 12). Also, the control unit 1301 performs overall control of the semiconductor chip 1.

The decoding unit 1302 decodes a pulse sequence (Rxdata) corresponding to a reception signal received via the reception circuit 1322 into a bit string, by sampling the pulse sequence at a predetermined sampling frequency.

The ID acquisition unit 1303 acquires the transmission source ID from the reception signal. The transmission source ID that is acquired by the ID acquisition unit 1303 is referred to in steps S904 and S905 in FIG. 9, for example.

The collision determination unit 1304 determines whether a collision occurred between wireless transmissions performed by a plurality of communication apparatuses (see steps S901 to S903 in FIG. 9).

An ID storage unit 1311 is realized by part of the storage area of the memory 20. IDs of the semiconductor chips 1 included in the communication system and information (coupling relationship information) indicating the coupling relationship between the semiconductor chips 1 are stored in advance in the ID storage unit 1311. The semiconductor chip 1 is able to identify other semiconductor chips 1 that are directly communicable therewith by inductive coupling in the communication system, by referring to the coupling relationship information.

A transmission circuit 1321 is realized by the transmitting coil 30 and the transmitting-side conversion circuit 50. The transmission circuit 1321 performs wireless transmission to another semiconductor chip 1 through inductive coupling between the transmitting coil 30 of the semiconductor chip 1 and the receiving coil 40 of the other semiconductor chip 1.

A reception circuit 1322 is realized by the receiving coil 40 and the receiving-side conversion circuit 60. The reception circuit 1322 performs wireless reception from the other semiconductor chip 1 through inductive coupling between the receiving coil 40 of the semiconductor chip 1 and the transmitting coil 30 of the other semiconductor chip 1.

### Summary of the Embodiments

According to the above embodiments, it becomes possible to improve the possibility of retransmission being performed in the case of a collision occurring in a communication system.

Note that no particular limitation is intended with regard to the specific configurations of software (a program) and hardware for implementing various types of functions that have been described in the foregoing embodiments. Arbitrary software, arbitrary hardware, and an arbitrary combination of arbitrary software and arbitrary hardware are encompassed within the scope of the foregoing embodiments, as long as they are technically possible.

The invention is not limited to the foregoing embodiments, and various variations/changes are possible within the spirit of the invention.

What is claimed is:

1. A first communication apparatus comprising:
a transmission circuit including a transmitting coil and configured to perform wireless transmission to a second communication apparatus through inductive coupling between the transmitting coil of the first communication apparatus and a receiving coil of the second communication apparatus;
a reception circuit including a receiving coil and configured to perform wireless reception from the second communication apparatus through inductive coupling between the receiving coil of the first communication apparatus and a transmitting coil of the second communication apparatus; and
a processor which functions as:
a determination unit configured to determine whether a collision occurred between wireless transmissions performed by a plurality of communication apparatuses, based on a reception signal received via the reception circuit, wherein the reception signal is a pulse sequence, and the determination unit determines whether the collision occurred, based on at least one of a frequency and a pulse width of the pulse sequence; and
a control unit configured to, in a case where the collision occurred, perform control to transmit a retransmission request to the second communication apparatus via the transmission circuit.

2. The first communication apparatus according to claim 1,
wherein the processor further functions as a decoding unit configured to decode the pulse sequence into a bit string by sampling the pulse sequence at a predetermined sampling frequency, and
wherein the determination unit determines that the collision occurred, in a case where the frequency of the pulse sequence is higher than the predetermined sampling frequency.

3. The first communication apparatus according to claim 1,
wherein the processor further functions as a decoding unit configured to decode the pulse sequence into a bit string by sampling the pulse sequence at a predetermined sampling frequency, and
wherein the determination unit determines that the collision occurred, in a case where the pulse sequence includes a pulse having a width different from an integer multiple of a pulse width corresponding to a period of one cycle of the predetermined sampling frequency.

4. A first communication apparatus comprising:
a transmission circuit including a transmitting coil and configured to perform wireless transmission to a second communication apparatus through inductive coupling between the transmitting coil of the first communication apparatus and a receiving coil of the second communication apparatus;
a reception circuit including a receiving coil and configured to perform wireless reception from the second communication apparatus through inductive coupling between the receiving coil of the first communication apparatus and a transmitting coil of the second communication apparatus; and
a processor which functions as:
a determination unit configured to determine whether a collision occurred between wireless transmissions performed by a plurality of communication apparatuses, based on a reception signal received via the reception circuit, wherein the determination unit determines that the collision occurred, in a case where there is a bit error in the reception signal; and
a control unit configured to, in a case where the collision occurred, perform control to transmit a retransmission request to the second communication apparatus via the transmission circuit.

5. The first communication apparatus according to claim 1,
wherein the processor further functions as an acquisition unit configured to acquire transmission source identification information from the reception signal.

6. The first communication apparatus according to claim 5,
wherein the receiving coil of the first communication apparatus is inductively coupled to the transmitting coil of the first communication apparatus, and
in a case where identification information of the second communication apparatus is acquired as the transmission source identification information, and the collision occurred while a wireless transmission via the transmission circuit is being executed, the control unit performs control to transmit the retransmission request to the second communication apparatus, by including the identification information of the second communication apparatus as destination identification information in the retransmission request.

7. The first communication apparatus according to claim 5,
wherein, in a case where the transmission source identification information is not acquired and the collision occurred, the control unit performs control to transmit the retransmission request to a plurality of communication apparatuses including the second communication apparatus, by including, as destination identification information in the retransmission request, respective pieces of identification information of the plurality of communication apparatuses, and
each of the plurality of communication apparatuses has a transmitting coil inductively coupled to the receiving coil of the first communication apparatus.

8. The first communication apparatus according to claim 5,
wherein, in a case where the transmission source identification information is not acquired and the collision occurred, the control unit performs control to broadcast the retransmission request.

9. The first communication apparatus according to claim 5,
wherein, in a case where the transmission source identification information is not acquired and the collision occurred, the control unit performs control to transmit a plurality of retransmission requests corresponding to a plurality of communication apparatuses including the second communication apparatus,
each of the plurality of communication apparatuses has a transmitting coil inductively coupled to the receiving coil of the first communication apparatus, and
each of the plurality of retransmission requests includes identification information of a corresponding communication apparatus as destination identification information.

10. The first communication apparatus according to claim 1,
wherein the receiving coil of the first communication apparatus is inductively coupled to the transmitting coil of the first communication apparatus, and
the collision includes a collision between wireless transmissions performed by the first communication apparatus and the second communication apparatus.

11. The first communication apparatus according to claim 1,
wherein the receiving coil of the first communication apparatus is inductively coupled to a transmitting coil of a third communication apparatus, and
the collision includes a collision between wireless transmissions performed by the second communication apparatus and the third communication apparatus.

12. A first communication apparatus comprising:
a transmission circuit including a transmitting coil and configured to perform wireless transmission to a second communication apparatus through inductive coupling between the transmitting coil of the first communication apparatus and a receiving coil of the second communication apparatus;
a reception circuit including a receiving coil and configured to perform wireless reception from the second communication apparatus through inductive coupling between the receiving coil of the first communication apparatus and a transmitting coil of the second communication apparatus; and
a processor which functions as
a control unit configured to, in a case where, after a first transmission signal is transmitted to the second communication apparatus via the transmission circuit, a first retransmission request is received from the second communication apparatus via the reception circuit, perform control to retransmit the first transmission signal to the second communication apparatus via the transmission circuit,
wherein, in a case where the first retransmission request includes information indicating that a plurality of retransmission requests including the first retransmission request is transmitted by the second communication apparatus, the control unit performs control to retransmit the first transmission signal after the plurality of retransmission requests are received via the reception circuit.

13. The first communication apparatus according to claim 12,
wherein, in a case where a second retransmission request addressed to a communication apparatus other than the first communication apparatus is received via the reception circuit, the control unit performs control to temporarily refrain from performing the wireless transmission via the transmission circuit.

14. A control method executed by a first communication apparatus, wherein
the first communication apparatus comprises:
a transmission circuit including a transmitting coil and configured to perform wireless transmission to a second communication apparatus through inductive coupling between the transmitting coil of the first communication apparatus and a receiving coil of the second communication apparatus; and
a reception circuit including a receiving coil and configured to perform wireless reception from the second communication apparatus through inductive coupling between the receiving coil of the first communication apparatus and a transmitting coil of the second communication apparatus, and
the control method comprises:
determining whether a collision occurred between wireless transmissions performed by a plurality of communication apparatuses, based on a reception signal received via the reception circuit, wherein the reception signal is a pulse sequence, and whether the collision occurred is determined based on at least one of a frequency and a pulse width of the pulse sequence; and
in a case where the collision occurred, performing control to transmit a retransmission request to the second communication apparatus via the transmission circuit.

15. A control method executed by a first communication apparatus, wherein
the first communication apparatus comprises:
a transmission circuit including a transmitting coil and configured to perform wireless transmission to a second communication apparatus through inductive coupling between the transmitting coil of the first communication apparatus and a receiving coil of the second communication apparatus; and
a reception circuit including a receiving coil and configured to perform wireless reception from the second communication apparatus through inductive coupling between the receiving coil of the first communication apparatus and a transmitting coil of the second communication apparatus, and
the control method comprises
in a case where, after a first transmission signal is transmitted to the second communication apparatus via the transmission circuit, a first retransmission request is received from the second communication apparatus via the reception circuit, performing control to retransmit the first transmission signal to the second communication apparatus via the transmission circuit,
wherein, in a case where the first retransmission request includes information indicating that a plurality of retransmission requests including the first retransmission request is transmitted by the second communication apparatus, the first transmission signal is retransmitted after the plurality of retransmission requests are received via the reception circuit.

16. A non-transitory computer-readable storage medium which stores a program for execution by a processor of a first communication apparatus, wherein
the first communication apparatus comprises:
a transmission circuit including a transmitting coil and configured to perform wireless transmission to a second communication apparatus through inductive coupling between the transmitting coil of the first communication apparatus and a receiving coil of the second communication apparatus; and
a reception circuit including a receiving coil and configured to perform wireless reception from the second communication apparatus through inductive coupling between the receiving coil of the first communication apparatus and a transmitting coil of the second communication apparatus, and
the program, when executed by the processor, causes the processor to perform:
determining whether a collision occurred between wireless transmissions performed by a plurality of communication apparatuses, based on a reception signal received via the reception circuit, wherein the reception signal is a pulse sequence, and whether the collision occurred is determined based on at least one of a frequency and a pulse width of the pulse sequence; and
in a case where the collision occurred, performing control to transmit a retransmission request to the second communication apparatus via the transmission circuit.

17. A non-transitory computer-readable storage medium which stores a program for execution by a processor of a first communication apparatus, wherein
the first communication apparatus comprises:
a transmission circuit including a transmitting coil and configured to perform wireless transmission to a second communication apparatus through inductive coupling between the transmitting coil of the first communication apparatus and a receiving coil of the second communication apparatus; and
a reception circuit including a receiving coil and configured to perform wireless reception from the second communication apparatus through inductive coupling between the receiving coil of the first communication apparatus and a transmitting coil of the second communication apparatus, and
the program, when executed by the processor, causes the processor to perform
in a case where, after a first transmission signal is transmitted to the second communication apparatus via the transmission circuit, a first retransmission request is received from the second communication apparatus via the reception circuit, performing control to retransmit the first transmission signal to the second communication apparatus via the transmission circuit,
wherein, in a case where the first retransmission request includes information indicating that a plurality of retransmission requests including the first retransmission request is transmitted by the second communication apparatus, the first transmission signal is retransmitted after the plurality of retransmission requests are received via the reception circuit.
